(19) United States
(12) Patent Application Publication
(10) Pub. No.: US 2025/0343467 A1
(43) Pub. Date: Nov. 6, 2025

(54) COOLING WHEEL FOR ACTIVELY COOLING A STATOR OF AN ELECTRIC MOTOR

(71) Applicant: ebm-papst Mulfingen GmbH & Co. KG, Mulfingen (DE)

(72) Inventors: Michael STURM, Bad Mergentheim-Rot (DE); Christian PFAFF, Künzelsau (DE)

(21) Appl. No.: 18/869,948

(22) PCT Filed: May 26, 2023
(86) PCT No.: PCT/EP2023/064152

§ 371 Date: Nov. 27, 2024

(30) Foreign Application Priority Data
May 31, 2022 (DE) 10 2022 113 706.6

(51) Int. Cl. H02K 9/06; H02K 9/22

(52) U.S. Cl. CPC H02K 9/06; H02K 9/227; H02K 2209/00

(57) ABSTRACT

A cooling wheel (1) for actively cooling a stator (2) of an electric motor (3). The cooling wheel (1) can be fixed in a rotationally fixed manner adjacent to the stator (2) on a rotor (4) of the electric motor (3), which is rotatable about an axis of rotation (A). The cooling wheel has a bottom disc (10) that extends orthogonally to the axis of rotation (A) with an annular radially inner portion (12) and a radially outer portion annularly extending around it. The cooling wheel (1) has, in the axial direction adjacent to the radially outer portion of the bottom disc (10), a cover disc (30) that annularly extends around the axis of rotation (A). A plurality of blades (20) extend from the bottom disc (10) to the cover disc (30) and radially outwards. A flow channel is formed between two immediately adjacent blades (20) which is delimited by the two blades (20), a portion (11) of the bottom disc (10), located between the two blades and a portion (31) of the cover disc (30), located between the two blades (20). The respective portion (31) of the cover disc (30) is designed to be arcuate in the circumferential direction (U). The cover disc (30) has an undulating profile on its outer circumference (32).

### CROSS-REFERENCE TO RELATED APPLICATIONS

This application is a 371 U.S. National Phase of International Application No. PCT/EP2023/064152, filed on Mar. 26, 2023 and also claims the benefit of German Application No. 10 2022 113 706.6, filed on May 31, 2022. The entire disclosures of the above applications are incorporated herein by reference.

### DESCRIPTION

The disclosure relates to a cooling wheel for actively cooling a stator with a stator electronics of an electric motor and an electric motor with such a cooling wheel. A plurality of solutions for cooling stators for electric motors is known from the prior art. Often, only a passive cooling is provided, wherein the stator provides cooling fins, for example, via which heat is released into the environment without a defined fluid flow and in particular air flow being generated thereon.

Since a defined cooling is only possible to a limited extent without a defined flow, such solutions are subject to a plurality of restrictions.

Alternatively, concepts for active cooling are also known in the prior art and for example from DE 10 2012 107 109 A1, in which a fluid flow, i.e. an air flow, is actively generated and used to cool the stator.

However, particularly at higher or increasing speeds, the noise development and the torque requirement of such a cooling wheel can become unfavourable and lead to impaired efficiency and a high noise level.

The disclosure is therefore based on the object of overcoming the aforementioned disadvantages and of providing a cooling wheel for actively cooling a stator of an electric motor, which has the lowest possible torque requirement and the lowest possible noise emissions even at higher speeds.

This object is achieved by the combination of features according to the disclosure.

Therefore, according to the disclosure, a cooling wheel for actively cooling a stator of an electric motor is proposed, wherein the electric motor in particular is an external rotor motor. In order to cool the stator, the cooling wheel can be fixed in a rotationally fixed manner adjacent to the stator on a rotor of the electric motor that is rotatable about an axis of rotation. Preferably, the electric motor is the motor of a fan so that, further and additionally to the cooling wheel, an impeller can be provided on the rotor. According to the invention, it is provided that the cooling wheel has a bottom disc extending orthogonally to the axis of rotation with an annular radially inner portion and a radially outer portion which annularly extends around the former and therefore is also annular. The cooling wheel further possesses, in the axial direction, i.e. along the axis of rotation or an axis parallel to the axis of rotation, adjacent to the radially outer portion of the bottom disc, a cover disc which annularly extends around the axis of rotation and a plurality of blades extending from the bottom disc to the cover disc and radially outwards. As seen from the side of the cover disc, the radially outer portion of the bottom disc preferably corresponds to the projection of the cover disc on the bottom disc. A flow channel is formed between two immediately adjacent blades, which is delimited by the two immediately adjacent blades, a portion of the bottom disc located between the two blades and a portion of the cover disc located between the two blades.

Correspondingly, the cooling wheel has a plurality of flow channels which are adjacent to one another in the circumferential direction and which are each delimited by two blades, the cover disc and the bottom disc. In order to reduce noise emissions, in particular at high speeds, the respective portion of the cover disc is designed to be arcuate or curved in the circumferential direction, so that the cover disc has an undulating profile on its outer circumference in the circumferential direction.

The curvature can in particular be designed to be convex, so that the portions of the cover disc that span a gap between two immediately adjacent blades and therefore delimit the respective flow channel curve away from the bottom disc outwards or towards the stator.

Preferably, the cooling wheel is made of plastic and in particular in an injection moulding process. In order to avoid a complex tool for manufacturing, which requires, for example, a plurality of slides, it is preferably provided that the bottom disc and cover disc are designed separately from one another and then joined. In doing so, the blades can be manufactured integrally with the bottom disc or the cover disc. The cover disc and the bottom disc, on which the blades can each be designed, can then be connected, for example, by hot stamping, so that the cooling wheel is integral.

In the present case, the stator is understood to also mean in particular the stator socket on which the cooling fins mentioned later are designed and which surrounds further components of the stator, such as in particular stator electronics, as a housing.

The stator in particular has the stator socket with stator package and stator electronics, wherein the stator electronics is a control unit for controlling the electric motor.

In order to optimise the suction side flow, it can also be provided that the radially inner portion of the bottom disc and an area adjacent in the axial direction are free of the blades and the cover disc and, in particular, other flow obstacles. The radially inner portion can be arranged in the axial direction adjacent to the stator, wherein the blades are designed to convey fluid, in particular air, from the radially inner portion of the bottom disc as the suction side of the stator through the flow channels, which are formed by the blades, to the radial outside and in particular in a radially adjacent environment as the pressure side.

The radially inner portion of the bottom disc can also be further optimised in terms of flow technology by designing or providing a continuous transition on the radially inner portion of the bottom disc from radially outside to radially inside from a portion of the bottom disc that is substantially orthogonal to the axis of rotation, which can be the radially outer portion of the bottom disc, to a portion of the bottom disc that is substantially parallel to the axis of rotation. The transition forms a continuous suction contour. As seen in a longitudinal portion along the axis of rotation, the radially inner portion can correspondingly have a concave course from radially outside to radially inside.

In relation to the portions of the cover disc that delimit a flow channel, their respective curvature can also become larger from radially inside to radially outside. In the circumferential direction, the curvature on an inner circumference of the cover disc can, for example, also be 0 and increase to radially outside.

A curvature of the portions or generally the arcuate portions preferably each have a maximum with respect to their course in the circumferential direction, which is preferably arranged symmetrically in the circumferential direction on the respective flow channel. Alternatively, however, several maxima and/or an asymmetrical arrangement of the maxima(s) are also possible.

Preferably, the radially inner portion of the bottom disc has a continuous, i.e. edge-free and jump-free course and is in particular free of flow obstacles.

In order to fix the cooling wheel on the rotor, fastening elements can be arranged in the radially inner portion of the bottom disc. For example, through holes are provided in the bottom disc for this purpose, through which screws can be inserted as fastening elements. The fastening elements allow the cooling wheel or the bottom disc of the cooling wheel to be fastened to the rotor or to a flange ring that can be fixed to the rotor.

Further, the fastening elements can also be provided on the inner circumference of the bottom disc.

The fastening elements are screws or latching elements, for example.

In particular, if latching elements are provided on the radially inner portion of the bottom disc, these can be adjacent in the circumferential direction on both sides of spring elements, which are designed to compensate for a tolerance and to hold the cooling wheel on the rotor or the flange ring without play.

In order to prevent, for example, screw heads or fastening elements in general from representing flow obstacles in the radially inner portion of the bottom disc, a cover element can be arranged adjacent to the fastening elements on a surface of the bottom disc on the cover disc side, which therefore faces an electric motor in the direction of the stator. The cover elements are designed to cover the fastening element on the cover disc side surface and to provide a continuous course that is in particular flat to the surface of the bottom disc and thus flow-optimised on the cover disc side surface of the bottom disc.

Further preferably, the cover elements or the respective cover element can be designed to be surface-integrated, so that the cover disc side surface of the bottom disc merges into the cover disc side surface of the respective cover element without a course jump.

In or on the radially inner portion of the bottom disc, recesses can also be provided, which form depressions opposite a or the cover disc side surface of the bottom disc, into which the fastening elements can be arranged at least partially recessed. For example, screw heads of screws serving as fastening elements can be sunk into the recess. In general, the recesses or depressions can achieve that the fastening elements can be arranged completely below the cover disc side surface of the radially inner portion of the bottom disc.

In particular if the cooling wheel is provided on a fan or the electric motor of a fan, a version is advantageous in which the bottom disc has connection interfaces for connecting an impeller on a side facing away from the cover disc. The connection interfaces can in particular be designed as bolts extending parallel to the axis of rotation or as pockets designed in the bottom disc for receiving insert nuts.

If the cooling wheel is not fixed directly to the rotor, but to the rotor via an annular flange, for example, the bolts extending parallel to the axis of rotation or in the axial direction can also be designed on the annular flange or integrated into it.

Such bolts can in particular also be designed as threaded stud bolts.

In order to optimise the flow generated by the blades, the blades preferably possess a sickle blade geometry and are curved from radially inside to radially outside in the circumferential direction. Preferably, the blades are curved forwards. A sickle blade geometry is particularly advantageous when the rotor or cooling wheel possesses a single predetermined direction of rotation.

If, on the other hand, it is provided that the rotor or the cooling wheel can be driven in both directions of rotation, so that the cooling wheel is designed for both clockwise and anti-clockwise rotation, the blades preferably have a straight or only slightly curved blade geometry.

One aspect of the disclosure also relates to an electric motor with a stator, a rotor that is rotatable about an axis of rotation and a cooling wheel according to the invention arranged on the rotor for cooling the stator. The stator and rotor are preferably arranged one after the other in the axial direction, wherein the electric motor in particular is an external rotor motor. Further preferably, the electric motor can also be the motor of a fan, which can have an impeller connected to the rotor on the rotor. The cooling wheel is arranged on an end portion of the rotor on the stator side in the axial direction and borders directly on the stator with the radially inner portion of the bottom disc, so that when the rotor rotates, a fluid flow from a portion of the stator adjacent to the radially inner portion of the bottom disc in the axial direction through the flow channels radially outwards is generated.

Further, the cooling wheel can be fixed directly to the rotor with its bottom disc. Alternatively, the cooling wheel can be fixed with its bottom disc on a flange ring, which is fixed on the rotor. If such a flange ring is provided, bolts pointing away from the cooling wheel, in particular threaded stud bolts, can be provided on it, for example to fix an impeller on the flange ring. Alternatively, recesses corresponding to the connection interfaces of the bottom disc can also be provided in the flange ring, so that a fastening means for fastening, for example, the impeller can be screwed through the recesses into the connection interfaces of the bottom disc of the cooling wheel.

In order to improve cooling, the stator and in particular the stator socket of the stator can have cooling fins arranged distributed in the circumferential direction around the axis of rotation, which are arranged in the axial direction directly adjacent to the radially inner portion of the cooling wheel and extend in particular in the radial direction.

The cooling wheel also preferably determines, on the radially inner portion of the bottom disc, a suction space which is delimited by the bottom disc, the blades and the cover disc and which annularly extends around the axis of rotation and is open to the stator, wherein the cooling fins extend into the suction space.

An advantageous further development also provides that the cooling wheel and in particular the bottom disc design a labyrinth seal with the stator on a radially inner circumference.

The features disclosed above can be combined as required, provided this is technically possible and they do not contradict one another.

Other advantageous refinements of the disclosure are characterized in the subclaims and/or depicted in greater detail below together with the description of the preferred embodiment of the invention with reference to the figures. In the drawings:

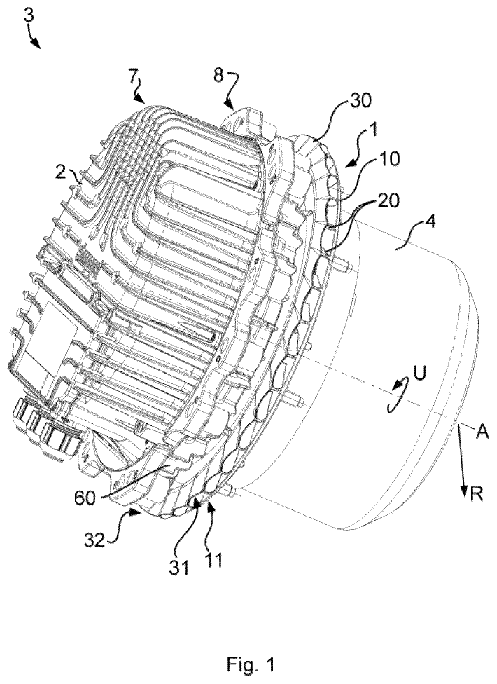

FIG. 1 shows an electric motor for a fan with a cooling wheel;

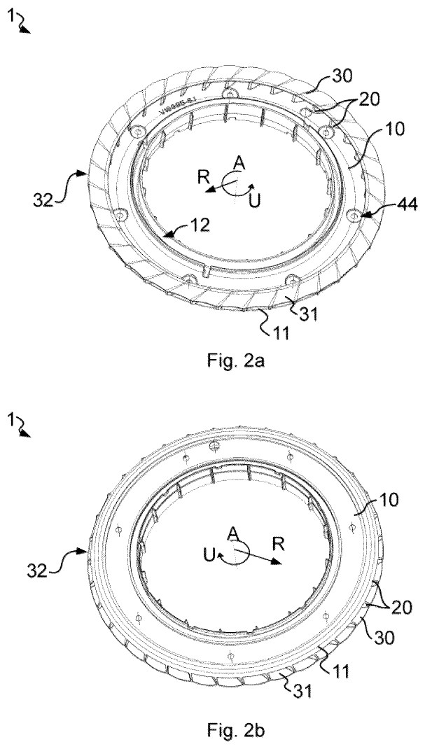

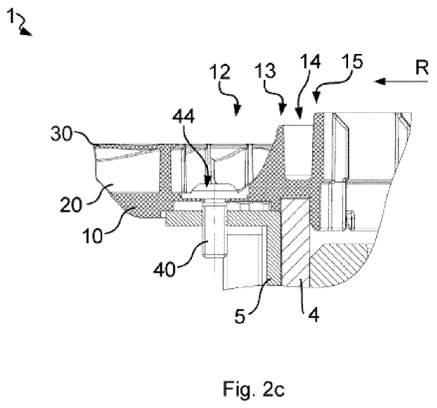

FIG. 2a-c shows different views of a first version of a cooling wheel;

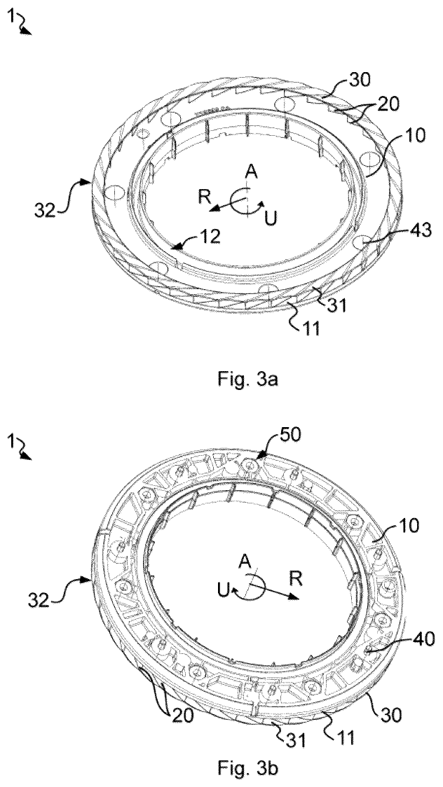

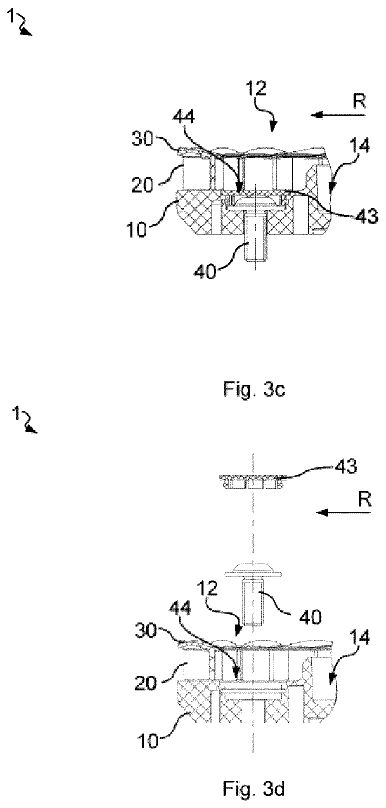

FIG. 3a-d shows different views of a second version of a cooling wheel;

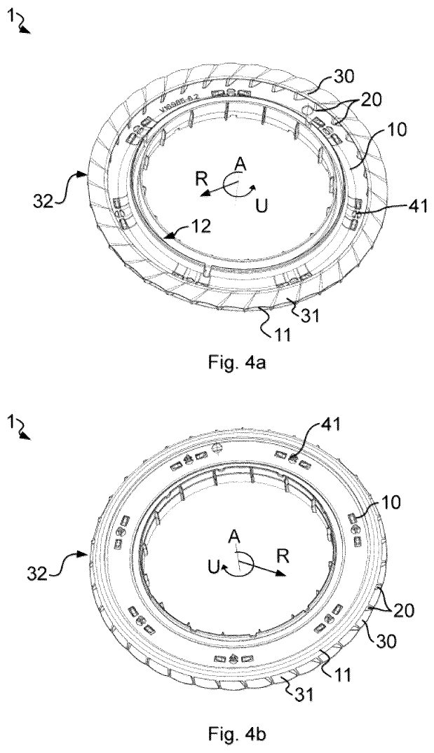

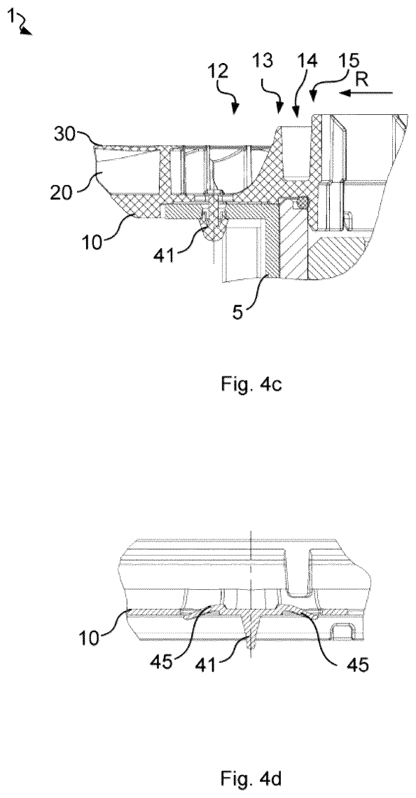

FIG. 4a-d shows different views of a third version of a cooling wheel;

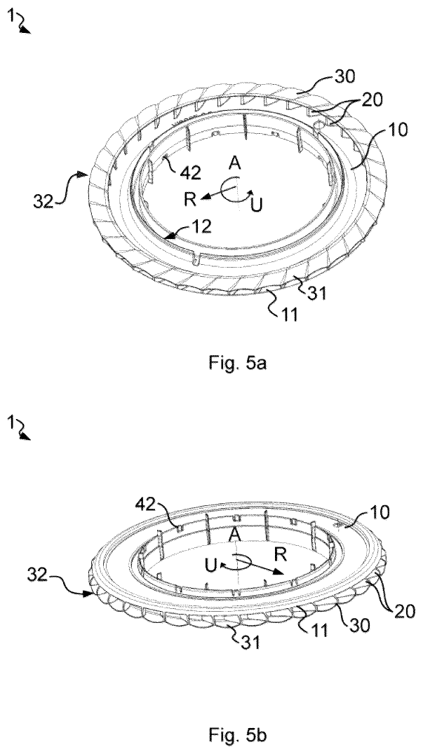

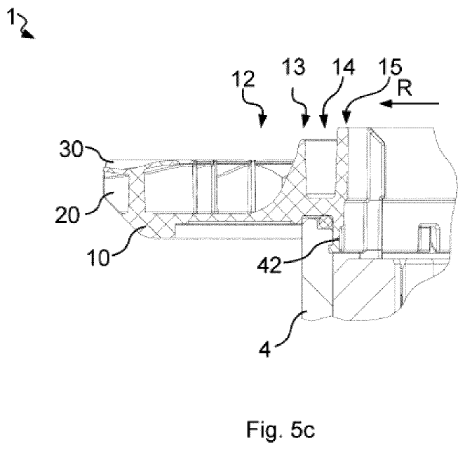

FIG. 5a-c shows different views of a fourth version of a cooling wheel;

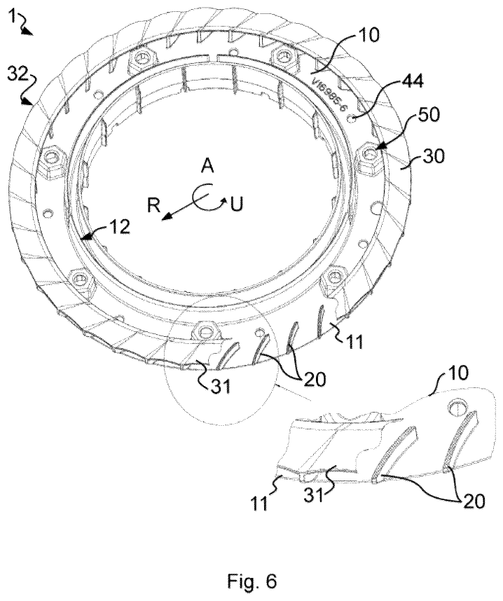

FIG. 6 shows a perspective view with a break of a fifth version of a cooling wheel;

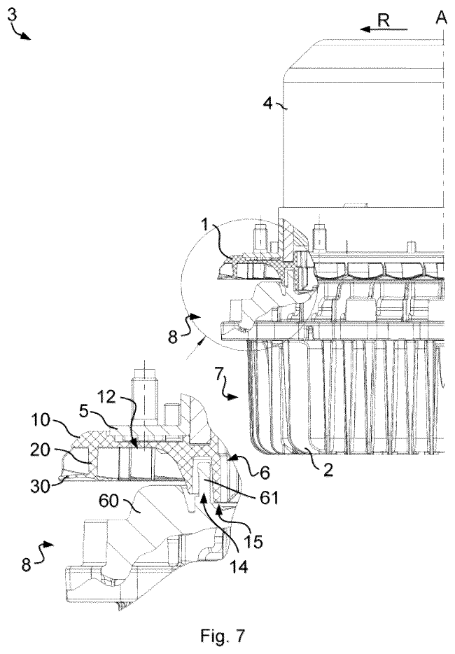

FIG. 7 shows a side view with a break and a detailed view of a first version of an electric motor;

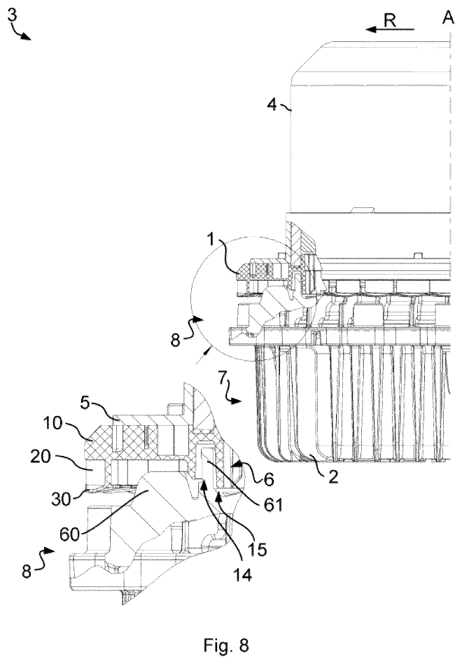

FIG. 8 shows a side view with a break and a detailed view of a second version of an electric motor;

The figures are schematic examples. Same reference symbols in the figures indicate same functional and/or structural features.

In FIG. 1, an electric motor 3, in particular for a fan, is represented in its entirety, so that its stator 2, the rotor 4 and the cooling wheel 1 are visible. The rotor 4 is rotatable about the axis of rotation A, wherein the cooling wheel 1 arranged in the axial direction, i.e. along the axis of rotation A between the rotor 4 and the stator 2, is fixed to the rotor 4 and therefore rotates together with the rotor 4 about the axis of rotation A. In doing so, the cooling wheel 1 actively generates an air flow from radially inwards to radially outwards. Correspondingly, the cooling wheel 1 has a suction side radially inside and adjacent to the stator 2 and a pressure side radially outside or on the outer circumference of the cooling wheel 1. This means that air is actively sucked in via the stator 2 and blown out radially outside.

The stator 2 in particular has an enclosed stator electronics 7 and a stator socket 8, wherein the cooling fins 60 are designed on the stator socket 8, which extend on or into the suction space of the cooling wheel 1.

Both for the cooling wheel 1 represented in FIG. 1 and for all cooling wheels represented in the further figures, it applies that these each have a bottom disc 10, a plurality of blades 20 and a cover disc 30. The blades 20 are, as can be seen in particular in FIGS. 2a, 2c, 3a, 3c, 3d, 4a, 4c, 5a, 5c and 6 to 8, exclusively arranged in a radially outer portion, i.e. outside in the radial direction R, which annularly extends around the axis of rotation A, of the bottom disc 10 and are covered by the cover disc 30 in the axial direction or towards the stator. It is provided in each case that a portion 12 located radially inside, i.e. on the inside in the radial direction R and annularly extending around the axis of rotation A, is free of blades 20, the cover disc 30 and in particular free of further flow obstacles, so that on the radially inner portion 12, a suction room which is open to the stator 2 in the state of being arranged on the stator 2 is formed, through which air from the stator 2 can be sucked in a flow-optimised manner.

In order to generate an optimised flow, the blades 20 each have a sickle geometry and are preferably inclined against the intended direction of rotation. Two blades 20 arranged directly next to each other form a flow channel between them, which is delimited in the circumferential direction U by the blades 20 and in the axial direction by a portion 11 of the bottom disc 10 and a portion 31 of the cover disc 30. Correspondingly, the flow channel is opened in the radial direction R.

Experiments have shown that a significant reduction in the noise generated by the cooling wheel 1 is achieved, in particular at high speeds, if the cover disc 30 is not designed to be flat, but has a wave-like shape in the circumferential direction U. Correspondingly, it is provided that each of the portions 31 of the cover disc 30 which delimit a flow channel, i.e. between two immediately adjacent blades 20, is designed to be arcuate or curved. This results in a continuous change between maxima and minima in the circumferential direction and thus the waveform.

As represented in the corresponding figures, the cover disc 30 or its portions 31 possesses no or only a minimal curvature on the inner circumference, which becomes larger radially outward, i.e. in the radial direction R away from the axis of rotation A.

Although the transition between two portions 31 or between the two arcs determined by the portions 31 can also be abrupt, it is preferably provided that the transition is continuous, so that there is no edge between two portions 31 or the two arcs determined by them, but rather a smooth transition is designed.

FIGS. 2a to 2c show a first version of a cooling wheel 1. FIG. 2a represents a perspective view of a side facing the stator 2 in the assembled state and FIG. 2b represents a side of the cooling wheel 1 facing the rotor 4 or facing away from the stator 2. FIG. 2c shows a part of a longitudinal portion along the axis of rotation A through the cooling wheel 1.

The version according to these figures is characterised in particular in that the cooling wheel 1 can be fixed to the rotor 4 via an annular flange 5, as represented in FIG. 2c. For this purpose, a plurality of recesses 44 arranged distributed in the circumferential direction is represented on the radially inner portion 12, through which screws can be screwed as fastening elements 40 to the annular flange 5. The recesses 44 are designed as a sunken or stepped through hole, so that the screw heads of the screws are at least partially sunk into the bottom disc 10 and represent a smaller flow obstacle, as can be seen in particular in FIG. 2c.

In order to optimise flow, it is further provided that the bottom disc 10 has a flow-optimised course from the radially outer portion towards the radially inner or in the radially inner portion 12 towards the axis of rotation A. It is formed in that a continuous transition is designed from a portion of the bottom disc 10 that is orthogonal to the axis of rotation A, which in the present case substantially corresponds to the radially outer portion, to a portion 13 of the bottom disc 10 that is parallel to the axis of rotation A, which results in a concave course. Along this transition, the air sucked in via the stator 2 is deflected in the direction of the flow channels and accordingly radially outwards.

An annularly extending groove 14 and an annularly extending projection 15 are also formed radially on the inside, which form a labyrinth seal 6 with corresponding elements of the stator.

FIGS. 3a to 3d show an alternative version, wherein FIG. 3a represents a stator side view and FIG. 3b represents a rotor side view.

As is in particular represented in FIGS. 3a, 3c and 3d, screws are provided as fastening elements 40, wherein the recesses 44 are designed so deep that the screw heads are completely recessed and lie below the surface determining the stator side of the bottom disc 10. In order to further optimise the flow along this surface, cover elements 43 are also provided, wherein one cover element 43 closes a recess 44 and covers a screw or a fastening element 40. The cover elements 43 are, as shown in FIG. 3c, integrated flat into the stator side surface of the bottom disc 10, so that this surface or the radially inner portion 12 of the bottom disc 10 is free of flow obstacles.

If the cooling wheel 1 is to be used, as according to FIGS. 3a to 3d, preferably on an electric motor 3 of a fan, an impeller can also be fixed to the rotor 4 via the flange ring 5, not represented. For this purpose, connection interfaces and, in this case, pockets 50 are provided in the bottom disc 10, in which insert nuts are held. Corresponding openings are provided in the flange ring 5 so that an impeller can be arranged on the flange ring 5 and screwed to the insert nuts held in the pockets 50. Alternatively, screws or screw heads can also be inserted into the pockets so that the thread of the screws runs through the annular flange 5.

The version of the cooling wheel 1 represented in FIGS. 4a to 4d is characterised in particular in that latching elements 41 are provided as fastening elements for fastening to an annular flange 5. In the present case, these are designed integrally with the bottom disc 10, but can also be provided separately.

As disclosed in FIG. 4c, the latching elements 41 penetrate the annular flange 41 and latch with it by resilient arms. In order to prevent a play allowing movement to remain between the annular flange 5 and the bottom disc 10, it is also provided that the latching element 41 is adjacent to a spring element 45 on both sides in the circumferential direction U, as is represented in the sectional view of FIG. 4d. The spring elements 45 are each supported on the annular flange 5 and thus keep the connection between the bottom disc 10 and the annular flange 5 free of play via the latching element 41.

As represented in FIG. 4c, in this version there is also provided a transition from the radially outer portion orthogonal to the axis of rotation A to the portion 13 parallel to the axis of rotation A, as well as a groove 14 and a projection 15 for producing a labyrinth seal 6.

In the version depicted in FIGS. 5a to 5d, it is provided that the cooling wheel 1 is not mounted or fixed on an annular flange 5, but rather directly on a stator side end face of the rotor 4. For this purpose, fastening elements designed as latching hooks 42 are provided on the inner circumference of the cooling wheel 1, which extend into the rotor 4 and latch on it, as can be seen in FIG. 5c. It is particularly advantageous that in the radially inner region 12 no fastening elements 40 have to be laminated or optimised in terms of flow technology and the region 12 is therefore free of flow obstacles.

FIG. 6 represents a cooling wheel 1 represented partially sectioned and an enlarged portion of this cooling wheel 1. Deviating from the version represented in FIGS. 3a to 3d, the bottom disc 10 also forms pockets 50 for receiving insert nuts, which, however, are not sunk under the stator side surface of the bottom disc 10, but protrude beyond it.

Due to the cutout and the enlargement of the cutout, in particular the sickled shape of the blades 20, which is inclined against the direction of rotation, is visible, as the blades 20 of each of the embodiments shown can have.

FIGS. 7 and 8 each show a side view of an electric motor 3 and a partial enlargement in the area of the cooling wheel 1.

In particular, the labyrinth seal 6 is shown in the respective enlarged portion, which is formed by the groove 14 and the projection 15 of the bottom disc 10 as well as a circumferential projection 61 of the stator, so that penetration of foreign particles into the interior of the motor 3 can be prevented.

Further, it is represented in both figures that the stator 2 designs a plurality of cooling fins 60 adjacent to the cooling wheel 1, which are arranged distributed in the circumferential direction around the axis of rotation A and extend along the radial direction R.

In FIG. 7, the cooling fins 60 are adjacent to the suction space, which is formed in the area of the radially inner portion 12 of the bottom disc 10 and is open in the axial direction towards the stator 2, so that air can be sucked into the suction space between the cooling fins 60, wherein the air flowing along the cooling fins 60 cools the stator 2.

The version represented in FIG. 7 preferably is the electric motor 3 according to FIG. 1.

In the embodiment according to FIG. 8, the cooling fins 60 are not only adjacent to the suction space, but extend into it.

The disclosure is not limited in its execution to the abovementioned preferred exemplary embodiments. Rather, a number of variants are conceivable which make use of the illustrated solution even in the form of fundamentally different embodiments.

1. A cooling wheel for actively cooling a stator of an electric motor, comprising:
the cooling wheel can be fixed in a rotationally fixed manner adjacent to the stator on a rotor of the electric motor which is rotatable about an axis of rotation and has a bottom disc that extends orthogonally to the axis of rotation with an annular radially inner portion and a radially outer portion annularly extending around it;
the cooling wheel has, in the axial direction adjacent to the radially outer portion of the bottom disc, a cover disc that annularly extends around the axis of rotation and a plurality of blades extending from the bottom disc to the cover disc and radially outwards;
a flow channel is formed between two immediately adjacent blades, which is delimited by the two blades, a portion of the bottom disc located between the two blades and a portion of the cover disc located between the two blades;
the respective portion of the cover disc is designed to be arcuate in the circumferential direction and the cover disc has an undulating profile on its outer circumference.

2. The cooling wheel according to claim 1, wherein the radially inner portion of the bottom disc and an area adjacent in the axial direction are free of the blades and the cover disc, can be arranged adjacent to the stator and the blades are designed, convey fluid from the radially inner portion of the bottom disc from the stator through the flow channels formed by them radially outwards.

3. The cooling wheel according to claim 1, wherein on the radially inner portion of the bottom disc, a continuous transition from radially outside to radially inside from a portion of the bottom disc which is orthogonal to the axis of rotation to a portion of the bottom disc which is parallel to the axis of rotation is designed so that a continuous suction contour is formed through the transition.

4. The cooling wheel according to claim 1, wherein a curvature of the respective arcuate portion of the cover disc becomes larger from radially inside to radially outside.

5. The cooling wheel according to claim 1,
wherein the radially inner portion of the bottom disc has a continuous course and is in particular free of flow obstacles.

6. The cooling wheel according to claim 1,
wherein in the radially inner portion of the bottom disc fastening elements are designed or can be arranged, for fastening the bottom disc to the rotor or a flange ring which can be fixed to the rotor.

7. The cooling wheel according to claim 6, wherein a cover element can be arranged on a cover disc side surface of the bottom disc adjacent to the fastening elements, which is designed to cover the fastening element, and to provide a continuous course that is in particular flat to the surface of the bottom disc on the cover disc side surface of the bottom disc.

8. The cooling wheel according to claim 6,
wherein in the radially inner portion of the bottom disc, recesses are provided, that form depressions opposite a cover disc side surface of the bottom disc, into which the fastening elements can be arranged recessed.

9. The cooling wheel according to claim 1,
wherein the bottom disc has connection interfaces for connecting an impeller on a side facing away from the cover disc,
wherein the connection interfaces are designed in particular as bolts extending parallel to the axis of rotation or as pockets for receiving insert nuts.

10. The cooling wheel according to claim 1,
wherein the blades have a sickle blade geometry and curve from radially inside to radially outside in the circumferential direction.

11. An electric motor with a stator, a rotor which that is rotatable about an axis of rotation and a cooling wheel arranged on the rotor according to claim 1 for cooling the stator, wherein the electric motor is in particular designed as an external rotor motor, and
the cooling wheel is arranged on an end portion of the rotor on the stator side in the axial direction and borders directly on the stator with the radially inner portion of the bottom disc, so that when the rotor rotates, a fluid flow is generated from a portion of the stator adjacent to the radially inner portion of the bottom disc in the axial direction through the flow channels radially outwards.

12. The electric motor according claim 11,
wherein the cooling wheel is fixed directly to the rotor with its bottom disc
or wherein the cooling wheel is fixed with its bottom disc on a flange ring, that is fixed on the rotor.

13. The electric motor according to claim 11,
wherein the stator has cooling fins arranged distributed in the circumferential direction around the axis of rotation, which are arranged in the axial direction directly adjacent to the radially inner portion of the cooling wheel and extend in particular in the radial direction.

14. The electric motor according to claim 13,
wherein the cooling wheel determines, on the radially inner portion of the bottom disc, a suction space that is delimited by the bottom disc, the blades and the cover disc, annularly extends around the axis of rotation and is open to the stator and wherein the cooling fins extend into the suction space.

15. The electric motor according to claim 11,
wherein the cooling wheel and in particular the bottom disc designs a labyrinth seal on a radially inner circumference with the stator.
